(19) United States
(12) Patent Application Publication
(10) Pub. No.: US 2026/0358172 A1
(43) Pub. Date: Nov. 12, 2026

(54) METHODS AND APPARATUS FOR OPTICAL MEASUREMENTS

(71) Applicant: American Electrodynamics Corp., Falls Church, VA (US)

(72) Inventor: Julia Mossbridge, Falls Church, VA (US)

(73) Assignee: American Electrodynamics Corp., Falls Church, VA (US)

(21) Appl. No.: 19/671,982

(22) Filed: May 8, 2026

Related U.S. Application Data
(60) Provisional application No. 63/803,117, filed on May 9, 2025.

(51) Int. Cl. G01J 1/44

(52) U.S. Cl. CPC G01J 1/44; G01J 2001/442

(57) ABSTRACT

An optical measurement system that includes a photon detector configured to collect photon count data during a pre-decision observation window comprising a plurality of defined observation intervals, each observation interval having a defined temporal duration; (b) a duration selection module configured to select a total post-decision observation duration from among a plurality of equiprobable durations after the photon count data of the pre-decision observation window has been recorded; and (c) a processor communicatively coupled to the photon detector, the processor configured to: (i) apply a high-pass filter to the collected photon count data to attenuate periodicities having periods above a threshold period, thereby producing filtered photon count data; (ii) perform a Fourier transform on the filtered photon count data to obtain a frequency spectrum; (iii) identify at least one peak magnitude and a corresponding peak frequency in the frequency spectrum; (iv) compute a cycles-per-run value based on the corresponding peak frequency and a post-decision observation time; and (v) determine the duration parameter based on a predetermined relationship between the cycles-per-run value and the peak magnitude.

### CROSS-REFERENCE TO RELATED APPLICATIONS

This application claims the benefit of U.S. Provisional Application No. 63/803,117, filed May 9, 2025, entitled Replication and Characterization of the Causally Ambiguous Duration-Sorting (CADS) Effect, the entirety of which is incorporated herein by reference.

### FIELD OF THE INVENTION

The present invention relates generally to measurement systems and, more particularly, to methods and apparatus for utilizing optical systems for characterizing duration-dependent variability in photon count data. Such measurement systems and methods can include one or more signal-processing techniques for extracting duration parameters from pre-duration-decision photon absorption measurements, informationally-isolated random number generation architectures for causally-ambiguous optical experiments, and methods for compensating photon-count measurements for lunar-phase-correlated systematic variability.

### BACKGROUND OF THE INVENTION

Several physical effects in quantum mechanics, including delayed-choice experiments and inhibited spontaneous emission, involve scenarios where measurements recorded at one time appear to correlate with events or decisions occurring at a later time. These phenomena have motivated investigations into retrocausal interpretations of quantum mechanics and related experimental designs. For example as described in more detail in Aharonov et al. (2010); Cohen et al. (2020a, 2020b); Cramer (1983); Leifer & Pusey (2017); Price (2012); Shimony (1989); Wharton (2018), all of which are incorporated by reference herein as if provided in their respective entireties.

Relatedly, an empirical effect termed the Causally Ambiguous Duration-Sorting (CADS) effect was initially reported in Mossbridge (2019) and further characterized in Mossbridge (2021). In the CADS paradigm, a non-laser light source is used to emit photons and a photon detector is used to count photon absorptions within defined observation windows. The parameter varied across experimental runs is the duration between the on-and off-times of the emitter and detector (the “optics”). This duration is randomly selected from among a set of equiprobable durations after an initial set of pre-decision observations have already been recorded. The primary observation is that experimental runs with different post-decision durations on the seconds-to-minutes time scale can be distinguished by differences in photon absorption counts recorded prior to the random decision about the future duration of the experimental run.

However, the original CADS experiments suffered from several technical constraints, including the use of failure-prone optical components as well as an increased risk of informational entanglement between measured variables and the randomization sources. Additionally, revised CADS experiments identified the existence of systematic variability in photon measurements correlated with lunar phase, which can create a need for compensation techniques in precision photon-counting metrology.

Therefore what is needed in the art is an improved approach for evaluating duration-dependent photon count variability, including systems and approaches that provide informational isolation between the randomization source and the measurement channel, continuous operation over extended periods, and quantitative signal-processing techniques for extracting duration parameters from pre-decision measurement data.

### SUMMARY OF THE INVENTION

In one arrangement, a system for determining a duration parameter associated with an optical measurement is provided. Here, the system includes: at least one photon detector configured to collect photon count data during a pre-decision observation window comprising one or more defined observation intervals, each observation interval having a defined temporal duration; (b) a duration-selection module configured to select an observation duration from among a plurality of equiprobable durations after the photon count data of the pre-decision observation window has been recorded; and (c) a processor communicatively coupled to the photon detector, the processor configured to: (i) apply a filter to the collected photon count data to attenuate periodicities having periods above and/or below a pre-defined threshold period, thereby producing filtered photon count data; (ii) perform a Fourier transform on the filtered photon count data to obtain a frequency spectrum; (iii) identify at least one peak magnitude and a corresponding peak frequency in the frequency spectrum; (iv) compute a cycles-per-run value based on the corresponding peak frequency and the selected post-decision observation duration; and (v) determine the duration parameter based on a predetermined relationship between the cycles-per-run value and the peak magnitude.

In another aspect, a method of determining a duration parameter associated with an optical measurement system is provided. Here, the described method comprises collecting photon count data during a pre-decision observation window comprising one or more defined observation intervals, applying a filter to attenuate periodicities above and/or below a threshold period, performing a Fourier transform on the filtered data to obtain a frequency spectrum, identifying at least one peak magnitude and corresponding peak frequency in the frequency spectrum, computing a cycles-per-run value based on the peak frequency and a post-decision observation time, and determining the duration parameter based on a predetermined relationship between the cycles-per-run value and the peak magnitude.

In another aspect, the present invention provides an optical measurement apparatus comprising a light source, a photon detector optically coupled to the light source, a pulse counting device configured to record photon counts over defined observation windows, a random number generator informationally isolated from the optical measurement channel, and a processor configured to execute the signal-processing and duration-parameter computation methods described herein.

In yet another aspect, the present invention provides a method of compensating photon-count measurements for lunar-phase-correlated variability, comprising operating a photon counting system over a time period spanning multiple lunar cycles, computing mean photon counts for each of a plurality of defined lunar phases, deriving a lunar-phase correction function based on the computed means, and applying the correction function to subsequent photon-count measurements.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a schematic diagram of elements of the apparatus described herein.

FIG. 2 is a flow diagram detailing the steps taken according to one or more methods or processes described herein.

FIG. 3 is a flow diagram further detailing the steps taken according to one or more methods or processes described herein.

FIG. 4 is a protocol schematic showing all four equiprobable post-decision durations following the pre-decision period.

FIG. 5A is a time series graph of photon counts in 11-second observation windows across 365 days showing the pre-filtered, original raw signal.

FIG. 5B is a time series graph of photon counts after high-pass filtering.

FIG. 6 is a Fast Fourier Transform (FFT) of the year-long signal after high-pass filtering, with the 6-hour period range indicated.

FIG. 7 is a graph of mean pre-decision photon counts from pre-filtered time series data plotted against lunar phase.

FIG. 8 is a graph of mean pre-decision photon counts from post-filtered data plotted against the number of post-decision observations.

FIG. 9A is a time series of t-scores for pre-decision means in comparisons between 6-hour windowed pre-decision means for 60 vs. 20 post-decision observations.

FIG. 9B shows resulting conservative sigmas corresponding to FIG. 9A.

FIG. 10 is a graph of mean conservative sigmas from 6-hour windows for each comparison of pre-decision means between post-decision durations.

FIG. 11 is a table of data obtained according to one embodiment of the described subject matter.

### DETAILED DESCRIPTION OF THE INVENTION

By way of overview and introduction, a system or apparatus is provided for determining a parameter associated with an optical measurement. More particularly, the system or apparatus described is configured to determine a duration parameter based on a pre-determined correlation between a calculated value and a measurement value.

In one non-limiting example, the system or apparatus described herein includes a photon detector configured to collect photon count data during a pre-decision observation window comprising one or more defined observation intervals, each observation interval having a defined temporal duration; (b) a duration-selection module configured to select a total post-decision observation duration from among a plurality of equiprobable durations after the photon count data of the pre-decision observation window has been recorded; and (c) a processor communicatively coupled to the photon detector, the processor configured to: (i) apply a low-, high-, or bandpass filter to the collected photon count data to attenuate periodicities having periods below and/or above threshold periods, thereby producing filtered photon count data; (ii) perform a Fourier transform on the filtered photon count data to obtain a frequency spectrum; (iii) identify at least one peak magnitude and a corresponding peak frequency in the frequency spectrum; (iv) compute a cycles-per-run value based on the corresponding peak frequency and a post-decision observation time; and (v) determine the duration parameter based on a predetermined relationship between the cycles-per-run value and the peak magnitude.

Turning now to the FIGs. provided herein, an apparatus is provided that includes a light or photon source 102, an optical measurement device 104, a processor 106, a data storage device 108, and one or more output devices 110.

In one or more configurations including a dedicated light source 102, the system described herein may utilize any device capable of emitting photons at one or more wavelengths suitable for detection by the optical measurement device. Suitable light sources 102 include, without limitation, light-emitting diodes (LEDs), organic light-emitting diodes (OLEDs), laser diodes, vertical-cavity surface-emitting lasers (VCSELs), superluminescent diodes, incandescent lamps, halogen lamps, arc lamps, gas discharge lamps, fluorescent sources, phosphorescent sources, blackbody radiation sources, and synchrotron or free-electron radiation sources. The light source 102 may emit at any wavelength or range of wavelengths across the electromagnetic spectrum, including ultraviolet, visible, near-infrared, mid-infrared, and far-infrared. The light source 102 may emit coherent or incoherent radiation, and may be continuous-wave or pulsed.

In certain embodiments, the light source 102 comprises a solid-state emitter such as a light-emitting diode or a laser diode. The emission wavelength of the solid-state emitter may be selected to fall within the sensitivity range of the optical measurement device, or may be deliberately offset from the peak sensitivity of the detector to achieve a desired attenuation effect. The light source 102 may be operated in a continuous-wave mode during observation intervals or may be modulated at a defined frequency. One or more optical elements may be disposed between the light source 102 and the detector to condition the emitted light, including diffusing elements to produce spatially uniform illumination, neutral density filters to reduce photon flux, bandpass filters to select a narrow wavelength range, polarizing filters to adjust phase, and fiber-optic couplers to direct photons from the source to the detector along a defined optical path. The optical path may be enclosed within a light-tight housing to exclude ambient photons, or may be partially open to permit a combination of source-emitted and ambient photons.

In one or more particular embodiments, the light source 102 comprises a red light-emitting diode having an emission wavelength of approximately 650 nm. The emitted light is diffused by a translucent diffusing element (e.g., translucent adhesive tape) to produce a spatially uniform photon distribution, and is attenuated by a de-tuned bandpass filter having a center wavelength of approximately 880 nm in the near-infrared range. Because the bandpass filter is spectrally offset from the LED emission wavelength, only a small fraction of the emitted photons pass through the filter, achieving the low photon count rate desirable for characterizing the CADS effect.

The attenuated photons are coupled to the detector via a fiber coupler. This configuration achieves an average photon count rate at the detector of approximately 3000 counts per second. The optics, including the LED, diffusing element, bandpass filter, and fiber coupler, are enclosed within a black box to exclude ambient light.

However, it will be appreciated and understood that in certain embodiments, no dedicated light source is utilized, and the light source 102 is ambient photons, including environmental visible light, thermal infrared radiation, or background radiation or any source. The selection of whether to include a dedicated light source, and the characteristics of that source, may be determined based on the desired photon count rate at the detector, the wavelength sensitivity of the detector, and the environmental conditions in which the system operates.

The optical measurement device 104 is configured to receive light (photons) generated by the light source 102. In one or more embodiments, the optical measurement device 104 is any device capable of detecting photons and producing a quantitative output indicative of photon flux, photon count, or photon absorption over a defined temporal interval. Suitable optical measurement devices 104 include, without limitation, spectrophotometers, photometers, radiometers, photodetectors, photodiode arrays, charge-coupled device (CCD) sensors, complementary metal-oxide-semiconductor (CMOS) image sensors, photomultiplier tubes, avalanche photodiodes, single-photon avalanche diodes (SPADs), single-photon counting modules, superconducting nanowire single-photon detectors, and bolometers.

The optical measurement device 104 may be configured to detect photons across any portion of the electromagnetic spectrum, including but not limited to ultraviolet, visible, near-infrared, and infrared wavelengths. In embodiments where an emitter is employed, the emitter and detector may operate at the same or different wavelengths. In alternative embodiments, no dedicated emitter is required, and the optical measurement device 104 is configured to detect ambient photons.

In certain embodiments, the optical measurement device 104 comprises a spectrophotometer or a photodetector configured to record photon measurement data as a time series of discrete measurements over observation intervals of defined temporal duration. In such a configuration, the spectrophotometer may be of any suitable type, including single-beam, double-beam, or array-based configurations, and may be configured to record absorbance, transmittance, or raw photon count values at one or more wavelengths over the defined observation intervals. Where the optical measurement device is a photodetector such a device may comprise a semiconductor-based detector such as a silicon photodiode, an indium gallium arsenide (InGaAs) photodiode, or a germanium photodiode, selected based on the wavelength range of interest. In embodiments where the CADS effect is to be characterized at conventional photon flux levels, a spectrophotometer operating in a time-resolved acquisition mode may be employed. In embodiments where low-photon-count operation is desired, the optical measurement device may be configured to operate at a photon count rate of fewer than approximately 10,000 counts per second.

In a preferred embodiment, the optical measurement device 104 comprises a single-photon counting module utilizing a reverse-bias diode, optically coupled to a light source via a fiber coupler. The light source comprises a light-emitting diode having an emission wavelength of approximately 650 nm, diffused by a translucent diffusing element and attenuated by a de-tuned bandpass filter having a center wavelength offset from the emission wavelength of the light source (e.g., an infrared bandpass filter having a center wavelength of approximately 880 nm used to attenuate a 650 nm source). The average photon count rate at the detector in this configuration is approximately 3000 counts per second.

In one or more arrangements, the pulses from the single-photon counting optical measurement device 104 are counted by an incorporated independent field programmable gate array (FPGA), and the counts over each pre-defined observation interval (e.g., 11 seconds) are summed and recorded.

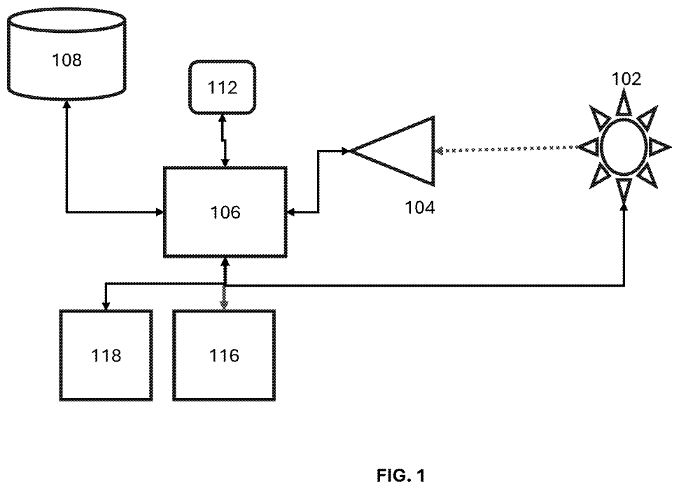

Continuing with the illustration of FIG. 1, the optical measurement device 104 and light source 102 are configured to communicate with one or more associated processors, networks, and storage devices using one or more USB, FIREWIRE, Wi-Fi, GSM, Ethernet, Bluetooth, and other wired or wireless communication technologies suitable for the transmission of, image, spectral, timing, or other relevant data and/or metadata. In an alternative arrangement, the light source 102 and optical measurement device 104 are combined into a single module or component of a computing workstation, testing bench, or other evaluative apparatus.

As discussed, in one or more arrangements, a parameter, such as the duration of a measurement or selection process, can be correlated to the measurement data obtained prior to the determination of the actual duration or selection parameter. The selection of one of at least two equally probable parameters (such as duration) is carried out by a dedicated selection module 112. Here, the selection module comprises any device, system, or process capable of selecting a post-decision operational state from among a plurality of equiprobable states after the pre-decision observation window has been recorded. It will be appreciated that the post-decision operational state may define any operational characteristic of the optical measurement system that varies across experimental runs, including but not limited to the duration of a post-decision observation period, the number of post-decision observation intervals, the intensity of the light source during a post-decision period, the wavelength of emitted or detected photons during a post-decision period, the polarization of detected photons during a post-decision period, or the sampling rate of the optical measurement device during a post-decision period.

The selection module 112 may be implemented as a hardware random number generator, a software-based pseudorandom number generator, a quantum random number generator, or any other source of randomness or selection logic capable of producing an output that selects among the plurality of equiprobable states. In certain embodiments, the selection may be performed by an external system or agent and communicated to the optical measurement systems described herein.

In one or more particular embodiments, the selection module 112 is informationally isolated from the optical measurement device such that the photon measurement data recorded during the pre-decision observation window is statistically independent of the selection mechanism. In alternative embodiments, the parameter selection module and the optical measurement device may share a common processor, provided that the selection output is not generated or determinable from the pre-decision photon measurement data.

In certain embodiments, the parameter-selection module 112 comprises a hardware random number generator physically separate from the optical measurement device 104. Here, a hardware random number generator may derive randomness from a physical process, including but not limited to radioactive decay, thermal noise, shot noise, photon arrival times from an independent photon source, or scintillation events in a scintillator material. The random physical process produces an unpredictable signal that is conditioned (e.g., amplified, discriminated, or digitized) and used to generate a selection output corresponding to one of the plurality of equiprobable states. To ensure informational isolation between the random number generator and the optical measurement device 104, a hardware random number generator may employ an independent photon source distinct from the light source 102, as well as independent detection and signal-conditioning circuitry, and independent clocking that is not derived from or synchronized with the control circuitry of the optical measurement device 104 as a whole.

The output of the parameter-selection module 112 may be communicated to a processor or control system via a digital interface (e.g., parallel digital lines, serial bus, or USB connection), and such a processor or control system uses the selection output to configure the post-decision operational state of the optical measurement system.

In a preferred embodiment, the parameter-selection module 112 comprises a shift-register pseudorandom number generator that is clocked by an independent clock source.

With continued reference to FIG. 1, processor 106 is communicatively coupled to the measurement device 104. Where a dedicated light source 102 is used, such light source is also coupled to the processor 106. In one or more implementations, the processor 106 is communicatively coupled to each illustrated component directly through one or more direct input and output interfaces. However, in one or more further implementations, the processor 106 is configured to communicate with a bus, hub, interface, or other component that manages the operation of one or more components based on processor 106 instructions.

In one particular implementation, the processor 106 is a computing device, such as a commercially available microprocessor, processing cluster, integrated circuit, computer on chip or other data processing device. In one or more configurations, the processor 106 is one or more components of a cellphone, smartphone, notebook or desktop computer configured to directly, or through a communication linkage, receive measurement data captured by the one or more sensors described herein.

The processor 106 is configured with code executing therein to access various peripheral devices and network interfaces. For instance, the processor 106 may be configured to communicate over the Internet with one or more remote servers, computers, peripherals or other hardware using standard or custom communication protocols and settings (e.g., TCP/IP, etc.). Alternatively, the processor 106, memory 105 and other components described herein are configured for local information or data processing and do not rely upon remote connections to carry out the processes described herein.

In one configuration, the processor 106 is a portable computing device such as an Apple iPad/iPhone® or Android® device or other commercially available mobile electronic device executing a commercially available or custom operating system, e.g., MICROSOFT WINDOWS, APPLE OSX, UNIX or Linux-based operating system implementations. In other embodiments, the processor 106 is, or includes custom or non-standard hardware, firmware or software configurations. For instance, the processor 106 comprises one or more of a collection of micro-computing elements, computer-on-chip, home entertainment consoles, media players, set-top boxes, prototyping devices or “hobby” computing elements. The processor 106 can comprise a single processor, multiple discrete processors, a multi-core processor, or other type of processor(s) known to those of skill in the art, depending on the particular embodiment.

The output signals generated by the light measurement device 104 are transmitted to one or more processor(s) 106 for evaluation as a function of one or more hardware or software modules. In one arrangement, the output signals generated by the light measurement device 104 are voltage measurements corresponding to the amount or intensity of light that is interacting with the light measurement device. As used herein, the term “module” refers, generally, to one or more discrete components that contribute to the effectiveness of the presently described systems, methods and approaches. Modules can include software elements, including but not limited to functions, algorithms, classes and the like. In one arrangement, the software modules are stored as software in memory of processor 106. Modules can, in some implementations, include discrete or specific hardware elements.

In one or more arrangements, the processor 106 is configured to execute one or more software modules to generate, calculate, process, output, or otherwise manipulate the output signals generated by the light measurement device 104.

In one or more embodiments, the processor 106 is directly or indirectly connected to one or more memory storage devices (memories) to form a microcontroller structure. The memory is a persistent or non-persistent storage device (such as memory 105) that is operative to store the operating system in addition to one or more of software modules. In accordance with one or more embodiments, the memory comprises one or more volatile and non-volatile memories, such as Read Only Memory (“ROM”), Random Access Memory (“RAM”), Electrically Erasable Programmable Read-Only Memory (“EEPROM”), Phase Change Memory (“PCM”), Single In-line Memory (“SIMM”), Dual In-line Memory (“DIMM”) or other memory types. Such memories can be fixed or removable, as is known to those of ordinary skill in the art, such as through the use of removable media cards or modules. In one or more embodiments, the memory of the processor 106 provides for the storage of application program and data files. One or more memories provide program code that the processor 106 reads and executes upon receipt of a start, or initiation signal. The computer memories may also comprise secondary computer memory, such as magnetic or optical disk drives or flash memory, that provide long term storage of data in a manner similar to the persistent memory device 105. In one or more embodiments, the memory 105 of the processor 106 provides for storage of application programs or modules and data files when needed.

As shown, memory 105 and persistent storage 108 are examples of computer-readable tangible storage devices. A storage device is any piece of hardware that is capable of storing information, such as data, program code in functional form, and/or other suitable information on a temporary basis and/or permanent basis. In one or more embodiments, memory 105 includes random access memory (RAM). RAM may be used to store data such as measurement data in accordance with the present invention. In general, memory can include any suitable volatile or non-volatile computer-readable storage device. Software and data are stored in persistent storage 108 for access and/or execution by processors 106 via one or more memories of memory 105.

In a particular embodiment, persistent storage 108 includes a magnetic hard disk drive. Alternatively, or in addition to a magnetic hard disk drive, persistent storage 108 can include a solid-state hard drive, a semiconductor storage device, read-only memory (ROM), erasable programmable read-only memory (EPROM), flash memory, or any other computer-readable storage devices capable of storing program instructions or digital information.

The database 108 may be embodied as solid-state memory (e.g., ROM), hard disk drive systems, RAID, disk arrays, storage area networks (“SAN”), network attached storage (“NAS”) and/or any other suitable system for storing computer data. In addition, the database 108 may comprise caches, including database caches and/or web caches. Programmatically, the database 108 may comprise flat-file data store, a relational database, an object-oriented database, a hybrid relational-object database, a key-value data store such as HADOOP or MONGODB, in addition to other systems for the structure and retrieval of data that are well known to those of skill in the art.

The media used by persistent storage 108 may also be removable. For example, a removable hard drive may be used for persistent storage 108. Other examples include optical and magnetic disks, thumb drives, and smart cards that are inserted into a drive for transfer onto another computer-readable storage medium that is also part of persistent storage 108.

In one or more further implementations, communications or network interface unit 116 provide for communications with other sub-systems or devices. In one or more particular embodiments, communications interface 116 may provide appropriate interfaces to the Internet or other suitable data communications networks to connect to one or more servers, resources, API hosts, or computers. In these examples, communications unit 116 may include one or more network interface cards. Communications unit 116 may provide communications through the use of either or both physical and wireless communications links.

In one or more implementations, a display device 118 is a screen, monitor, display, LED, LCD or OLED panel, augmented or virtual reality interface, or an electronic ink-based display device that is configured to output data processed by the processor 106. However, in one or more implementations, the display device 118 is remote from the processor 106. For example, in one or more implementations, the display device 106 is a smartphone or other device that is configured to receive measured and processed data from the processor 106 and display it to a user. Where the processor 106 or communication device is configured to communicate using Bluetooth or another communication technology, the display device 118 is configured to exchange data with the processor 106. Such data exchanges may include instructions to begin a measurement operation or update measurement calibration factors. Likewise, the results or measurements obtained using the integrating sphere may be provided to the display device 118 through the use of one or more software applications that reside on the display device 118. Such “app” based data interfaces allow for the hardware of the integrating sphere to be simplified and allow for remote device management and operation.

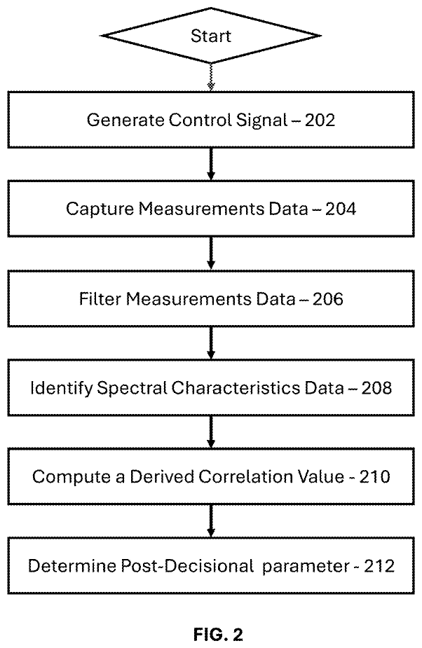

Turning now to FIG. 2, a flow diagram is provided to illustrate the processing of data according to the disclosure provided herein.

For example, as shown in step 202, a control or initiation signal is generated. For example, a user may cause the measurement process to begin. However, in an alternative configuration, the measurement process can be scheduled, such as to occur on a pre-set schedule or interval. Alternatively, the measurement process can be triggered by an external system or agent communicating with the processor via a digital interface (e.g., USB, serial, network, or application programming interface), or by the processor 106 itself upon satisfaction of one or more predefined conditions (e.g., confirmation that the optical measurement device has completed a self-check, that the parameter selection module is operational, or that environmental conditions fall within acceptable ranges. However, here, sensing such environmental conditions is accomplished through the use of one or more additional environmental sensors beyond the light measurement device 104).

Upon receipt of the start command, the processor 106 is configured by an initiation module, such as in the form of code executing within the processor 106 that initiates a system activation sequence comprising powering on or enabling the optical measurement device 104, and, in embodiments employing a dedicated light source 102, powering on or enabling the light source 102. Such an activation sequence may (in one arrangement) include generating signals that trigger a warm-up period during which the light source 102 and light measurement device 104 are allowed to reach a stable operating state before measurement data is recorded. The duration of the warm-up period may be fixed, may be empirically determined for a given hardware configuration, or may be dynamically determined by the processor 106 based on real-time monitoring of the light measurement device 104 output stability.

Following completion of the activation sequence, the processor 106 initiates the measurement acquisition process by instructing the optical measurement device 104 to begin recording photon measurement data over a series of defined observation intervals constituting the pre-decision observation window, as shown in step 204.

For each observation interval, the optical measurement device 104 is configured to detect photons and produces a measurement value (e.g., a photon count, an integrated intensity, or an absorbance reading), and the processor 106 receives and stores the measurement value in association with a timestamp indicating the time at which the observation interval occurred. The processor 106 continues acquiring measurement values for each successive observation interval of the pre-decision observation window until the requisite number of pre-decision observation intervals has been completed.

Upon acquisition of the measurement data, the processor 106 is configured to apply one or more filtering operations to condition the data for subsequent frequency-domain analysis, as shown in step 206. Here, the photon measurement data obtained is step 204 may comprise raw photon counts, absorbance values, transmittance values, or any other quantitative output of the optical measurement device recorded over the defined observation intervals.

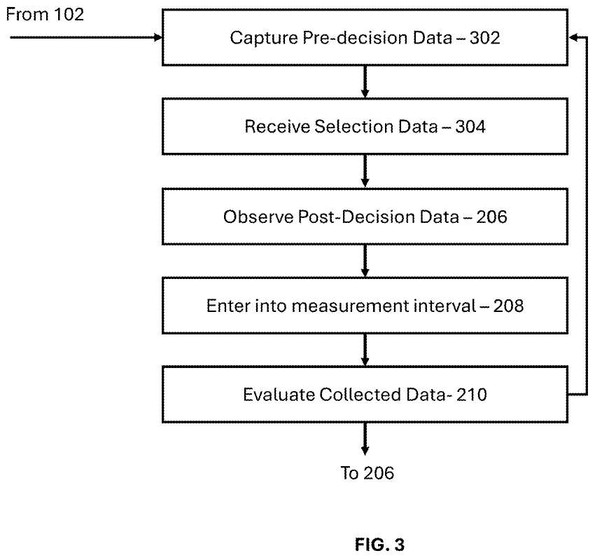

Referring now to FIG. 3, the capture measurements data step 204 of FIG. 2 is described in greater detail. In particular, it will be appreciated that the measurement step 204 further comprises an iterative measurement process in which the described measurement system executes a plurality of experimental runs, each run comprising a pre-decision observation phase, a decision point, a post-decision observation phase, and an inter-run interval. The iterative process repeats until a sufficient quantity of data has been accumulated for subsequent analysis.

As shown in step 302, the processor 106 initiates the pre-decision observation phase of an experimental run. The processor 106 activates the optical measurement device 104 and, in embodiments employing a dedicated light source 102, activates the light source 102. Here, the optical measurement device 104 collects photon measurement data over a defined number of pre-decision observation intervals, each interval having a defined temporal duration. During the pre-decision observation phase provided in step 302, the processor receives and stores the photon measurement data from each pre-decision observation interval. Upon completion of the final pre-decision observation interval, the processor 106 computes a pre-decision measurement value for the run (e.g., the arithmetic sum or mean of the photon counts recorded across the pre-decision observation intervals) and stores the pre-decision measurement value in memory 105 or 108.

Upon completion of the pre-decision measurement data collection in step 302, the processor 106 is configured to cause an instruction to be sent to the parameter selection module 112 to generate a selection output identifying one of the plurality of equiprobable post-decision operational states. This step 302 occurs at the decision point, that is, after the pre-decision observation phase of step 302 has been completed and the pre-decision measurement value for the current run has been recorded and stored.

The parameter selection module 112 is instructed by the processor 106 to generate the selection output independently of the pre-decision photon measurement data, and communicate the selection output to the processor 106. The processor 106 receives the selection output and identifies the corresponding post-decision operational state.

Turning now to step 306, the processor 106 is configured by one or more modules, or code executing therein to implement a post-decision observation phase. In embodiments where the post-decision operational parameter is duration, the processor maintains the optical measurement device and, where applicable, the light source in an active state for the number of post-decision observation intervals specified by the selected state. In embodiments where the post-decision operational parameter is a characteristic other than duration, the processor adjusts the relevant operational characteristic to the value specified by the selected state and operates the system for a defined post-decision period at that adjusted value.

The optical measurement device may continue to record photon measurement data during the post-decision observation phase; however, the post-decision photon measurement data is not used in the frequency-domain analysis and parameter determination described herein. The post-decision observation phase is executed to completion for each run.

Continuing to step 308, following completion of the post-decision observation phase in step 306, the processor 106 records an association in memory between the pre-decision measurement value obtained in step 302 for the current run and the identity of the post-decision operational state selected at step 304. The association may be stored as a data record comprising the pre-decision measurement value, the post-decision state identifier, and a timestamp indicating the time at which the run was executed. The accumulated data records across all completed runs constitute the dataset from which the processor will subsequently partition, filter, and analyze the pre-decision measurement data on a per-state basis.

At step 308, the processor 106 is configured to enter into an inter-run interval during which the optical measurement device 104 and, where applicable, the light source 102 are deactivated. The inter-run interval provides a temporal separation between successive experimental runs. The duration of the inter-run interval may be fixed, configurable, or dynamically determined by the processor 106. During the inter-run interval, the processor 106 may perform housekeeping operations, including verifying the integrity of stored data, monitoring the status of the optical measurement device and the parameter selection module, and logging any error conditions.

At step 310, the processor 106 evaluates whether a sufficient quantity of data has been accumulated to proceed to the filtering and frequency-domain analysis steps (steps 206 through 210 of FIG. 2). The sufficiency determination may be based on a minimum number of completed experimental runs, a minimum number of runs per post-decision operational state, a minimum elapsed time of continuous operation, a statistical criterion applied to the accumulated data (e.g., a minimum expected statistical power for detecting spectral differences across post-decision states), or any combination thereof. If the sufficiency criterion has not been met, the processor returns to step 302 and initiates the next experimental run. If the sufficiency criterion has been met, the processor advances the accumulated dataset to step 206 for filtering. In embodiments where the system operates continuously, the processor 106 may periodically advance accumulated data to step 206 while simultaneously continuing to execute additional experimental runs, such that the measurement loop of step 204 and the analytical pipeline of steps 206 through 210 operate concurrently on overlapping datasets.

Returning now to FIG. 2, the processor 106 is configured, such as through one or more software modules, to apply a filter to the photon measurement data to attenuate or remove low-frequency components corresponding to periodicities that are unrelated to the post-decision operational parameter of interest, as shown in step 206.

It will be appreciated that such filtering operations include, without limitation, high-pass filters, band-pass filters, notch filters, wavelet-based decomposition filters, and polynomial detrending operations. It will be appreciated by those possessing an ordinary level of skill in the requisite art, that the applied filter may be implemented in the time domain (e.g., as a finite impulse response or infinite impulse response digital filter applied to the time-series data), in the frequency domain (e.g., by transforming the data, modifying frequency-domain magnitudes, and performing an inverse transform), or as a hybrid of both approaches. The filter parameters, including cutoff frequency, roll-off characteristics, and attenuation profile, may be selected based on the known or expected periodicity structure of the photon measurement data in the particular operating environment.

In embodiments where the photon measurement data exhibits long-period variability attributable to environmental factors such as temperature drift, diurnal cycles, or lunar-phase effects, the filter is configured to attenuate these longer periodicities while preserving shorter-period variability in which the post-decision-dependent signal resides.

In certain embodiments, the processor 106 is configured to apply a high-pass filter to the photon measurement data, the high-pass filter having a cutoff period selected to attenuate periodicities longer than a threshold period while leaving shorter-period variability substantially unattenuated. The high-pass filter may be implemented as a frequency-domain operation in which the processor 106 performs a Fourier transform on the photon measurement data. Here such a transformation, in one implementation, applies a magnitude-shaping function to the resulting frequency-domain representation to attenuate frequency components below a cutoff frequency corresponding to the threshold period, and performs an inverse Fourier transform to produce the filtered photon measurement data in the time domain. The magnitude-shaping function may comprise a step function, a linear ramp, an exponential ramp, a Gaussian roll-off, or any other monotonically increasing function that transitions from full attenuation at frequencies below the cutoff to no attenuation at frequencies above the cutoff.

The processor 106 may be further configured to verify the filtering result by comparing the frequency spectrum of the filtered data to the frequency spectrum of the unfiltered data, confirming that periodicities above the threshold period have been substantially removed. The threshold period may be set at a value that preserves periodicities on the time scale at which the post-decision operational parameter varies across experimental runs. For example, where the post-decision observation durations range from seconds to minutes, the threshold period may be set at a value on the order of tens of hours, such that diurnal and longer-period variability is attenuated while sub-diurnal variability associated with run-level differences is preserved.

In a preferred embodiment, the processor 116 is configured to apply an exponential-ramp high-pass filter to the Fourier-obtained magnitudes of the photon measurement data. The exponential-ramp function provides a smooth transition from full attenuation to no attenuation, avoiding the spectral leakage artifacts that may be introduced by sharp-cutoff filter designs. The filter is configured such that periodicities of approximately 57 hours and above are attenuated to substantially zero, periodicities of approximately 12 hours are attenuated to approximately 5.6% of their original magnitude, and periodicities of approximately 4.6 hours and shorter are completely unattenuated. As discussed in further detail herein, these parameters were empirically selected based on a year-long continuous dataset in which the pre-filtered photon measurement data exhibited prominent periodicities at 12-hour, 24-hour, and 25-to-32-day periods attributable to diurnal, semi-diurnal, and lunar-cycle effects, respectively, while the CADS-related signal of interest resided at periodicities on the order of hours.

The processor 106 executes the filtering by performing, such as by using one or more software modules that configure a processor, a Fast Fourier Transform on the time-series data, multiplying the resulting magnitude spectrum by the exponential-ramp shaping function, and performing an inverse Fast Fourier Transform to produce the filtered time-series data. The processor 106 is configured to store both the filtered and unfiltered data in the database 108, or memory 105 to enable subsequent analysis of long-period variability, including the lunar-phase correlation analysis described elsewhere herein.

Following computation of the frequency spectrum, the processor 106 is configured by one or more modules (such as by code executing therein) to identify one or more spectral characteristics within the frequency spectrum that are indicative of periodic structure in the pre-decision measurement data, as shown in step 208.

Those possessing an ordinary level of skill in the requisite art will appreciate that a spectral characteristic may comprise any feature of the frequency spectrum that can be quantitatively extracted and used as an input to a subsequent computation. For example, such spectral characteristics can include, without limitation, a peak magnitude, a peak frequency, a spectral centroid, a spectral bandwidth, a harmonic ratio, a spectral slope, a spectral moment, or any combination thereof. In preferred embodiments, the processor identifies one or more peak magnitudes and their corresponding peak frequencies, where a peak magnitude is defined as a local maximum in the frequency spectrum that exceeds the magnitudes of neighboring frequency components by a defined margin or that exceeds a defined threshold value. The processor 106, suitably configured, may identify peaks using any suitable peak-detection algorithm known in the art, including gradient-based methods, zero-crossing detection of the first derivative, prominence-based filtering, template matching, or adaptive thresholding. The number of peaks identified may be fixed (e.g., the top N peaks by magnitude) or may be dynamically determined based on the spectral characteristics of the data (e.g., all peaks exceeding a noise floor by a defined signal-to-noise ratio). The processor may identify peaks independently within each per-state frequency spectrum, or may identify peaks across multiple per-state spectra and compare their magnitudes and frequencies across post-decision operational states.

In certain embodiments, the processor 106 is configured to identify a defined number of the highest-magnitude peaks in each per-state frequency spectrum and to record both the magnitude and the corresponding frequency of each identified peak. The processor 106 ranks the frequency components within each per-state spectrum by magnitude in descending order and selects the top N peaks, where N is a configurable parameter. For each selected peak, the processor records a peak magnitude value (M_p) representing the amplitude of the spectral component and a peak frequency value (f_p) representing the frequency at which that magnitude occurs. The processor may further compute summary statistics across the identified peaks, including the mean peak magnitude, the mean peak frequency, or the variance of peak magnitudes across the top N peaks. In embodiments where peak frequencies are substantially consistent across per-state spectra (i.e., the same periodic components are present in the pre-decision data regardless of post-decision state, but at different magnitudes), the processor 106 may align peaks across spectra by frequency and compare magnitudes at corresponding frequencies.

It will be appreciated that in embodiments where peak frequencies differ across per-state spectra, the processor 106 records both the magnitude and frequency independently for each per-state spectrum to preserve the full spectral characterization.

In one or more particular embodiments, the processor 106 identifies the four highest-magnitude peaks in the single-sided amplitude spectrum for each of the four post-decision observation durations. For each of the four per-duration spectra, the processor records the peak magnitude (M_p) and the corresponding peak frequency (f_p) for each of the top four peaks, yielding a total of 16 magnitude-frequency pairs across the four post-decision durations. The identified peak frequencies correspond to periodicities in the range of approximately 12 to 24 hours in the 6-hour windowed pre-decision mean data.

The processor 106 is configured to store these magnitude-frequency pairs in a structured data format (e.g., a table indexed by post-decision observation duration and peak rank) for use in the subsequent computation of cycles-per-run values and determination of the post-decision operational parameter via the predetermined relationship. In the year-long continuous dataset, the top four peak magnitudes for each post-decision duration ranged from approximately 7.22 to 10.25, and the corresponding peak frequencies ranged from approximately 1.15×10\hat{ }−5 Hz to 2.29×10\hat{ }−5 Hz, corresponding to periods of approximately 12 to 24 hours.

Following identification of one or more spectral characteristics in the frequency spectrum, the processor 106 is configured to compute a derived value that relates the identified spectral characteristics to the post-decision operational parameter of the system, as shown in step 210.

A person of ordinary skill in the art will appreciate that the derived value may comprise any quantity computed from one or more of the identified spectral characteristics in combination with one or more known or measured properties of the experimental protocol, including the duration of the post-decision observation period, the number of post-decision observation intervals, the total duration of an experimental run, the sampling rate of the observation intervals, the phase of the detected data, or any other temporal or operational quantity that differs across post-decision operational states.

Here, the derived value serves as an intermediate quantity that normalizes or scales the spectral characteristics relative to the post-decision operational parameter, enabling comparison across post-decision operational states on a common basis. The derived value may be dimensionless or may carry physical units depending on the particular computation employed.

In one arrangement, the processor 106 may compute the derived value for each identified spectral characteristic independently (e.g., for each of the top N peaks in each per-state spectrum), or may compute a single aggregate derived value from a combination of spectral characteristics (e.g., a weighted mean across multiple peaks). The computation of the derived value may be performed using arithmetic operations, lookup tables, interpolation functions, or any other computational method implemented in software, firmware, or dedicated hardware executing on the processor.

In certain embodiments, the derived value comprises a cycles-per-run value representing the number of oscillation cycles at a given peak frequency that fit within the post-decision observation period of an experimental run. Here, processor 106 computes the cycles-per-run value by first determining the post-decision observation time in physical units (e.g., seconds), which may be calculated as the product of the number of post-decision observation intervals and the temporal duration of each observation interval. The processor 106 then multiplies the peak frequency (expressed in reciprocal time units, e.g., Hz) by the post-decision observation time (expressed in matching time units, e.g., seconds) to obtain the cycles-per-run value. Expressed formally, for a peak frequency f_p and a post-decision observation time obs_p, the cycles-per-run value C_r is computed as C_r=f_p×obs_p. The processor computes the cycles-per-run value for each combination of identified peak and post-decision operational state, producing a set of cycles-per-run values that span the range of spectral characteristics and post-decision states observed in the data.

In embodiments where the derived value is computed from the total run duration (i.e., including both the pre-decision and post-decision periods) rather than from the post-decision period alone, the processor substitutes the total run duration for the post-decision observation time in the computation, and the resulting cycles-per-run value reflects the periodicity relative to the entire experimental run.

In a preferred embodiment, the processor 106 computes the cycles-per-run value for each of the top four peaks identified in each of the four per-duration frequency spectra, yielding 16 cycles-per-run values. The post-decision observation time for each duration is calculated as the number of post-decision observations multiplied by the 11-second observation interval duration: 0 post-decision observations corresponds to 0 seconds, 20 post-decision observations corresponds to 220 seconds, 30 post-decision observations corresponds to 330 seconds, and 60 post-decision observations corresponds to 660 seconds.

For the 0 post-decision observation condition, the cycles-per-run value is zero regardless of peak frequency, reflecting the absence of a post-decision observation period. For the remaining three post-decision durations, the cycles-per-run values range from approximately 5.01×10\hat{ }−3 to approximately 1.51×10\hat{ }−2 across the top four peaks. The processor may additionally compute a mean cycles-per-run value across the top four peaks for each post-decision duration, providing a summary statistic that captures the central tendency of the spectral-temporal relationship for each post-decision operational state. These mean cycles-per-run values serve as the input to the predetermined relationship from which the post-decision operational parameter is determined, as described in the following section.

Following computation of the derived value as in step 210, the processor 106 is configured to determine the post-decision operational parameter by applying a predetermined relationship that maps the derived value and the identified spectral characteristic to a corresponding parameter value, as in step 212.

By way of overview, the predetermined relationship may comprise any mathematical function, model, or mapping that has been established through prior calibration, empirical observation, or theoretical derivation, and that relates one or more derived values and one or more spectral characteristics to the post-decision operational parameter. Suitable predetermined relationships include, without limitation, linear regression models, polynomial regression models, power-law relationships, logarithmic relationships, piecewise-linear models, neural network models, support vector regression models, Gaussian process models, lookup tables with interpolation, or any other function approximation or machine learning technique capable of capturing the empirical relationship between spectral features of pre-decision measurement data and the post-decision operational parameter. The predetermined relationship may be expressed as a closed-form equation with empirically derived coefficients, as a set of tabulated values with an associated interpolation rule, or as a trained computational model stored in memory accessible to the processor.

The processor 106 may apply the predetermined relationship to individual derived-value and spectral-characteristic pairs (e.g., for a single peak in a single per-state spectrum), or may apply it to summary statistics computed across multiple peaks or across multiple per-state spectra (e.g., mean derived values and mean spectral characteristics). The output of the predetermined relationship is a determined value of the post-decision operational parameter, which the processor may report to a user, store for subsequent analysis, or use as an input to a further computational process.

In certain embodiments, the predetermined relationship comprises a linear model of the form M_p=a×C_r+b, where M_p is the peak magnitude, C_r is the cycles-per-run value, and a and b are empirically derived constants established during a prior calibration procedure. The linear model may be derived by performing a least-squares regression on a calibration dataset comprising a plurality of empirically observed (C_r, M_p) pairs obtained from experimental runs with known post-decision operational parameters. The processor stores the coefficients a and b in memory and, during subsequent operation, applies the linear model to determine an unknown post-decision operational parameter by solving for the cycles-per-run value from an observed peak magnitude (C_r=(M_p−b)/a) and then computing the corresponding post-decision observation time from the cycles-per-run value and the known peak frequency (obs_p=C_r/f_p). The processor may apply the linear model using the mean peak magnitude and mean cycles-per-run value across the top N peaks, or may apply the model independently to each peak and aggregate the resulting parameter estimates (e.g., by computing a weighted or unweighted mean of the per-peak estimates). However, it will be appreciated that an alternative to the trial-by-trial approach is the approach described within Mossbridge 2025 (original document), which is to analyze and predict durations at the group-of-trials level. The processor may further compute a confidence measure associated with the determined parameter value based on the goodness of fit of the linear model (e.g., the R-squared value of the calibration regression), the variance of per-peak estimates, or the residual error between the observed spectral characteristics and the values predicted by the model. In embodiments where the predetermined relationship is periodically recalibrated, the processor may update the coefficients a and b based on newly accumulated data without interrupting the measurement process.

In a preferred embodiment, the predetermined relationship is a linear equation derived from a year-long continuous calibration dataset comprising approximately 1460 six-hour windowed mean values for each of four post-decision observation durations. The processor applies the CADS equation in either of two forms. In a first form, the processor uses the mean cycles-per-run value and mean peak magnitude across the top four peaks for each post-decision duration, applying the relationship M_p=−80.056×C_r+9.147 (R-squared=0.982). In a second form, the processor uses the cycles-per-run value and peak magnitude corresponding to the single largest peak for each post-decision duration, applying the relationship M_p1=−78.753×C_r1+9.1612 (R-squared=0.961). Both forms produce substantially equivalent determinations of the post-decision operational parameter. To determine an unknown post-decision observation duration from newly acquired pre-decision measurement data, the processor performs the filtering and frequency-domain analysis described herein, identifies the peak magnitude and peak frequency, computes the cycles-per-run value, and solves the applicable CADS equation for the post-decision observation time. For example, given an observed peak magnitude of M_p=8.5 and a peak frequency of f_p=2.29×10\hat{ }−5 Hz, the processor computes C_r=(9.147−8.5)/80.056=0.00808, and then computes the post-decision observation time as obs_p=C_r/f_p=0.00808/2.29×10\hat{ }−5=352.8 seconds, corresponding to approximately 32 post-decision observation intervals of 11 seconds each, which the processor may round or map to the nearest equiprobable duration (in this case, 30 post-decision observations corresponding to 330 seconds). The processor may output the determined parameter value as a continuous estimate, as a classification among the known equiprobable states, or as a probability distribution across the plurality of equiprobable states.

Additional implementations and embodiments are herein understood and appreciated. For example and in no way limiting, in one or more implementations, a method of compensating photon-count measurements for lunar-phase-correlated variability is provided, the method comprising: (a) operating a photon counting system over a calibration period spanning a plurality of complete lunar cycles, the photon counting system comprising a photon detector configured to record photon counts over defined observation intervals; (b) determining a lunar phase corresponding to each observation interval based on a timestamp associated with the observation interval; (c) computing a mean photon count for each of a plurality of defined lunar phases based on the photon counts recorded during the calibration period; (d) deriving a lunar-phase correction function based on the computed mean photon counts; and (e) applying the lunar-phase correction function to subsequent photon-count measurements to compensate for systematic variability attributable to lunar phase.

In yet further arrangements or embodiment, an optical measurement apparatus is provided, the measurement apparatus comprising a light source configured to emit photons; a photon detector optically coupled to the light source and configured to detect individual photon absorptions; an attenuating optical element disposed between the light source and the photon detector, configured to reduce the photon count rate at the detector; a pulse counting device configured to record photon counts over a plurality of defined observation windows; a random number generator informationally isolated from the photon detector, the random number generator configured to select a post-decision observation duration from among a plurality of equiprobable durations; control circuitry configured to operate the light source and the photon detector according to a protocol comprising a pre-decision observation period followed by the selected post-decision observation duration; and a processor configured to: receive pre-decision photon count data from the pulse counting device, apply a high-pass filter to the pre-decision photon count data, perform a Fourier transform on the filtered data to identify at least one peak magnitude and corresponding peak frequency, and compute a duration parameter based on a predetermined relationship between a cycles-per-run value derived from the peak frequency and the peak magnitude.

In a further embodiment, the apparatus of any of the previous embodiments, wherein the light source comprises a light-emitting diode having an emission wavelength of approximately 650 nm.

In a further embodiment, the apparatus of any of the previous embodiments, wherein the attenuating optical element comprises a de-tuned bandpass filter and a diffusing element.

In a further embodiment, the apparatus of any of the previous embodiments, wherein the photon detector comprises a single-photon counting module utilizing a reverse-bias diode.

In a further embodiment, the apparatus of any of the previous embodiments, wherein the pulse counting device comprises a field programmable gate array (FPGA) independent of a control computer executing the control circuitry.

In a further embodiment, the apparatus of any of the previous embodiments, wherein the random number generator comprises: a scintillator material configured to produce random light flashes; a photomultiplier configured to convert the random light flashes to electrical pulses; an amplifier and threshold discriminator configured to condition the electrical pulses; and a plurality of shift register integrated circuits clocked by the conditioned electrical pulses to generate pseudorandom bit sequences.

In a further embodiment, the apparatus of any of the previous embodiments, wherein the plurality of shift register integrated circuits comprises 10 CD4015 CMOS shift register chips implementing an 80-bit shift register.

In a further embodiment, the apparatus of any of the previous embodiments, wherein the control circuitry comprises an optically-isolated resistor-capacitor (RC) circuit for ramping a voltage to the light source.

In yet a further embodiment, a method of compensating photon-count measurements for lunar-phase-correlated variability is provided, the method comprising: (a) operating a photon counting system over a calibration period spanning a plurality of complete lunar cycles, the photon counting system comprising a photon detector configured to record photon counts over defined observation intervals; (b) determining a lunar phase corresponding to each observation interval based on a timestamp associated with the observation interval; (c) computing a mean photon count for each of a plurality of defined lunar phases based on the photon counts recorded during the calibration period; (d) deriving a lunar-phase correction function based on the computed mean photon counts; and (e) applying the lunar-phase correction function to subsequent photon-count measurements to compensate for systematic variability attributable to lunar phase.

In a further embodiment, the apparatus of any of the previous embodiments, wherein the plurality of defined lunar phases comprises nine phases, including a new moon phase separated into two days.

In a further embodiment, the apparatus of any of the previous embodiments, wherein the calibration period spans at least 12 complete lunar cycles.

The method of any of the previous embodiments, wherein the photon counting system operates at a count rate of approximately 3000 counts per second or fewer.

The method of any of the previous embodiments, wherein the lunar-phase correction function accounts for a photon-count valley at a new moon phase and photon-count peaks at waning gibbous and first quarter phases.

The of any of the previous embodiments, wherein the subsequent photon-count measurements are obtained from a system selected from the group consisting of: a quantum key distribution system, a single-photon LIDAR system, a photon-number-resolving detector calibration system, and a photonic quantum-computing timing system.

In yet a further embodiment, an optical measurement system is provided, the measurement system comprising: a photon detector configured to collect photon count data during a first observation window comprising a plurality of defined observation intervals, each observation interval having a defined temporal duration; a parameter selection module configured to establish a post-decision operational state of the optical measurement system from among a plurality of equiprobable states after the photon count data of the pre-decision observation window has been recorded; and a processor communicatively coupled to the photon detector, the processor configured to:
apply a filter to the collected photon count data to produce filtered photon count data; perform a frequency-domain transform on the filtered photon count data to obtain a frequency spectrum; identify at least one spectral characteristic in the frequency spectrum; compute a derived value based on the at least one spectral characteristic; and determine the post-decision operational parameter based on a predetermined relationship between the derived value and the at least one spectral characteristic.

### Experimental Set-Up, Results and Analysis

The Following Description Provides a Particular Embodiment of the Systems, methods and apparatus provided herein. The systems, methods and apparatus is described herein were used in connection with a year-long continuous experiment (Jul. 27, 2020 to Jul. 27, 2021) replicating and characterizing the Causally Ambiguous Duration-Sorting (CADS) effect. The experiment ran continuously for 365 days with consistent timing (+/−0.8 seconds), providing a dataset for characterizing duration-dependent photon count variability and, serendipitously, for documenting a novel relationship between photon counts and lunar phase.

### Protocol

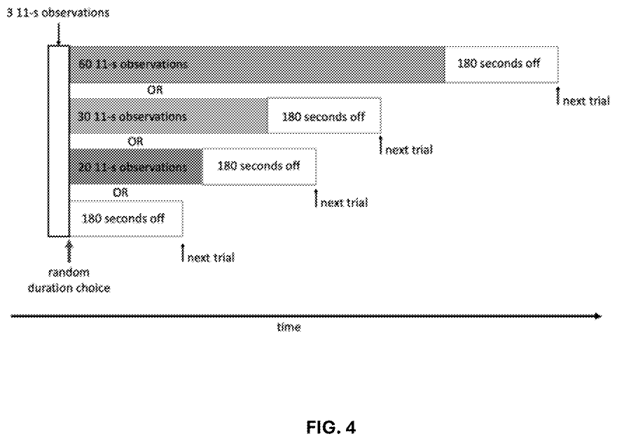

Referring to FIG. 4, the experimental protocol employed a non-laser light source and a detector to count photon absorptions within 11-second observation windows. The parameter varied across experimental runs was the duration between the on-and off-times of the emitter and detector (referred to herein as “the optics”). This duration was randomly selected from four equiprobable durations after the optics had already been turned on and three observations had already been recorded. The four possible post-decision observation counts were: 0 observations (the optics were immediately turned off), 20 observations (the optics were turned off after 220 seconds), 30 observations (the optics were turned off after 330 seconds), and 60 observations (the optics were turned off after 660 seconds). Immediately after the optics were turned off, a 180-second inter-run interval began.

In the year-long implementation, an additional 6 seconds were required to warm up the optics prior to each run, and it was found empirically that each run was an average of 3.199978 seconds +/−0.8 seconds longer than intended. Thus one run of the replication, including the 180-second inter-run interval, took 222.2 seconds (0 post-decision observations, total seconds of observation=33 seconds), 442.2 seconds (20 post-decision observations, total seconds of observation=253 seconds), 552.2 seconds (30 post-decision observations, total seconds of observation=363 seconds), or 882.2 seconds (60 post-decision observations, total seconds of observation=693 seconds). Each run was timestamped.

### Equipment—Optics

The desire was to attenuate photons reaching the detector, as the original effect had been found at relatively low counting rates. The optics were encased in a black box. The light source was a red (~650 nm) light-emitting diode (LED) that was diffused (via Magic Scotch tape) and attenuated by an infrared (~880 nm) de-tuned bandpass filter. The photons coupled were sent to the detector via a fiber coupler, to a single-photon counting module (i.e., a reverse-bias diode). Average count rate was about 3000 counts per second.

### Equipment—Input/Output and Control

Pulses from the detector were counted by an independent field programmable gate array (FPGA), and the counts over each 11-second observation window were summed and recorded by the controlling Labview software. The onset and offset times of the optics were controlled by Labview, which informed the resistor-capacitor (RC) circuit used for ramping the voltage up and down. This RC circuit was optically isolated from the computer to avoid ground loops.

### Equipment—Random Number Generation

A hardware random number generator was specifically designed to be informationally isolated from the optical measurement channel. A breadboard (i.e., discrete logic) implementation of an 80-bit shift register pseudorandom number generator was employed, clocked by independent photomultiplier pulses generated by a tank of scintillator oil. This provided a completely independent, non-computer based hardware random number generator. Flashes of light in the scintillator oil were converted to electrical pulses using a photomultiplier, with output sent through an amplifier and threshold discriminator. To make the four potential post-decision durations equiprobable, these truly random pulses were used as the clock inputs on 10 CD4015 CMOS integrated circuit (IC) shift register chips. Each time there was a detection in the scintillator oil tank, the circuit board advanced to the next pseudorandom number. The pseudorandom sequence repeated every 280-1 clocks. The approximate 40 Hz pulse rate of the scintillator oil provided a fresh 80 bits every 2 seconds. Two of these bits were collected by the Labview system via two jumper wires connecting to the circuit board with the 80-bit shift register.

### Equipment—Laboratory Environment

The replication was performed in a small room next to the Berkeley Advanced Physics lab which was seldom entered by Williams during the course of the year-long replication and was never entered by others. The room had one window with shades drawn and the space was climate controlled.

### Data Analysis—Dependent Variables

Once the third photon count was recorded, the decision was made by the control software using input from the random number generator. To characterize the CADS effect, the primary dependent variable was the arithmetic value of the summed photon counts in the first three 11-second observation bins, prior to the duration decision. At no time were post-decision photon counts analyzed for this report. Other dependent variables described herein are all derivations from these pre-decision means, except when the entire signal was used for high-pass filtering. No outliers were removed.

### Data Analysis—High-pass Filtering

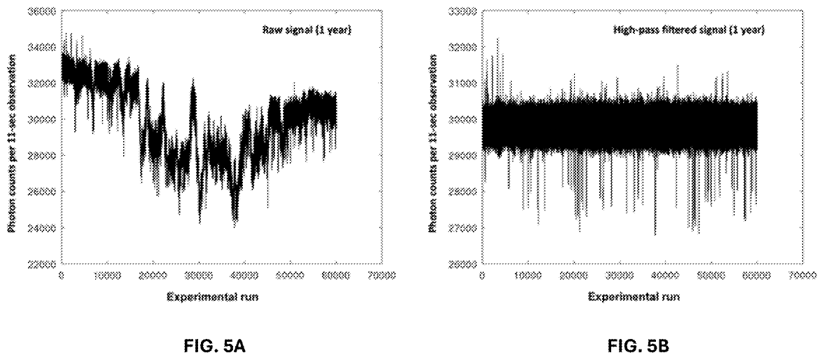

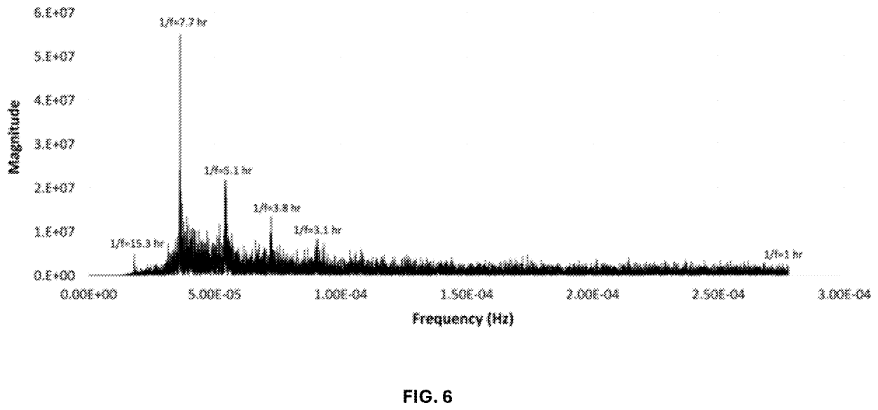

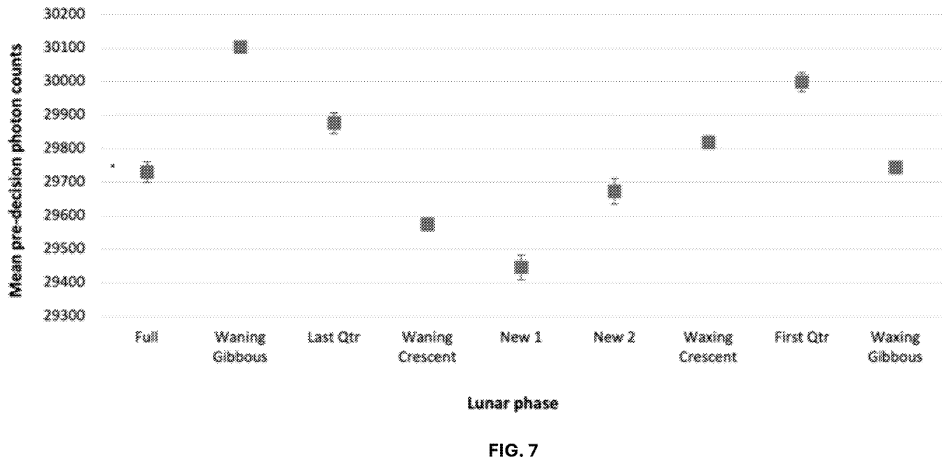

There were long time-frame periodicities in the 11-Hz sampled time series data; these corresponded to 12-, 24- and longer periods (e.g., 25-32 days, FIG. 5A). The effect of interest occurred at shorter time frames, and it was possible that these longer periodicities would make detecting that effect difficult. Matlab was used to apply an exponential-ramp high-pass filter to the Fourier-obtained magnitudes. An inverse Fourier transform was used to check that the longer periodicities were indeed removed from the time series (FIG. 5B). A Fourier transform of the filtered data indicated that the filter attenuated periods of ~57 hours and above to 0, at periods of ~12 hours magnitudes were at 5.6% of the original values, and at ~4.6 hours they were completely unattenuated (FIG. 6). The mean values used as dependent variables were calculated from the high-pass filtered time series, except where explicitly noted.

### Data Analysis—Calculating Lunar Phases

Because the period of one of the longer periodicities in the pre-filtered data was around the time of a lunar cycle (25-32 days), the pre-filtered time series data were examined to determine if there was any relationship between the mean pre-decision photon counts and the moon phases during the time the photon counts were gathered. To find the lunar phases for each experimental run, a modified Matlab interpretation of a Python script (Minkukel Plus) was applied to the Unix date/time stamps for each run, converting Unix date/time stamps to nine lunar phases, with the new moon separated into two days.

### Data Analysis—Examining Periodicities in Pre-decision Means

A 6-hour duration of the time window for the periodicity analysis was selected for three reasons: 1) given the equiprobability of the post-decision durations, 6 hours would be enough time to contain around 10 instances of each of the post-decision durations; 2) the post-filtered data showed no special peak at periods around 6 hours (FIG. 6, red asterisk), so any fluctuation that differed between pre-decision means across post-decision durations would be easier to detect than if a natural peak existed at that period; and 3) the original CADS effect was obtained from data gathered in 5-to-6 hour windows each day. The mean and standard deviations across all pre-decision means within each 6-hour window were calculated separately for each post-decision duration, providing 1460 6-hour means and standard deviations for each post-decision duration. One of these 6-hour time periods did not contain any durations that consisted of 20 observation windows, so data from that time period was deleted from all four post-decision duration datasets except the preceding FFT analysis of the 6-hour-windowed time series data.

To determine whether the observed periodicities were statistically reliable, the 6-hour means and standard deviations were used to calculate sigmas (as Z-scores derived from t-distributions) for comparisons of each of the 1459 windows between each of the four equiprobable post-decision durations, resulting in 1459 sigmas representing the absolute value of the effect for each post-decision duration comparison at each time window. To obtain sigmas for values that were incalculable, a sigma of 8.21 was artificially imposed by subtracting a very small value (1×10−16) from the probability density function.

### Data Analysis—FFT Analysis Per Post-Decision Duration

The time series of the 6-hour windowed pre-decision photon count means were independently transformed for each post-decision duration with FFT (Matlab) using a 21600-second sampling period. Before the FFT was performed, the removed mean value was replaced with the average of the two surrounding mean values in the time series for each post-decision duration dataset.

### Results

### Equipment Performance

The equipment ran successfully without fail for 365 days with consistent timing (+/−0.8 seconds), providing a remarkably generous dataset for characterizing the CADS effect.

### Lunar Phase and Photon Counts

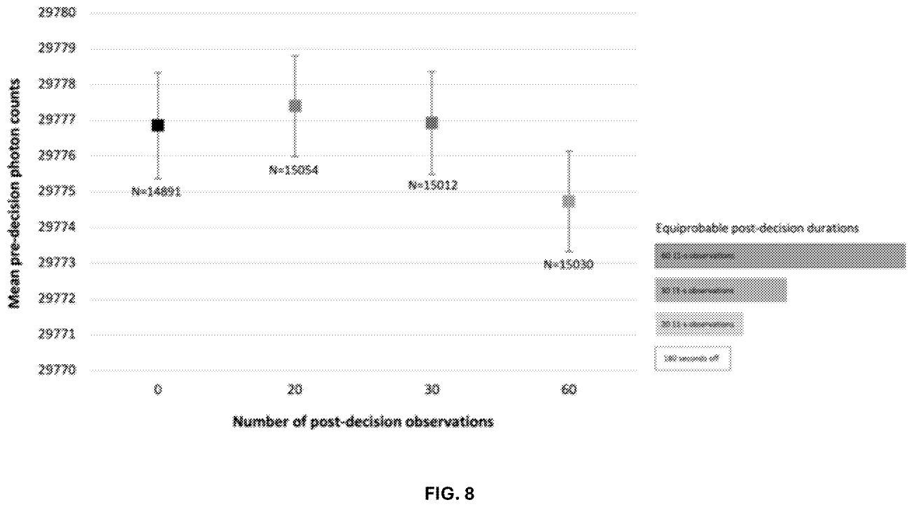

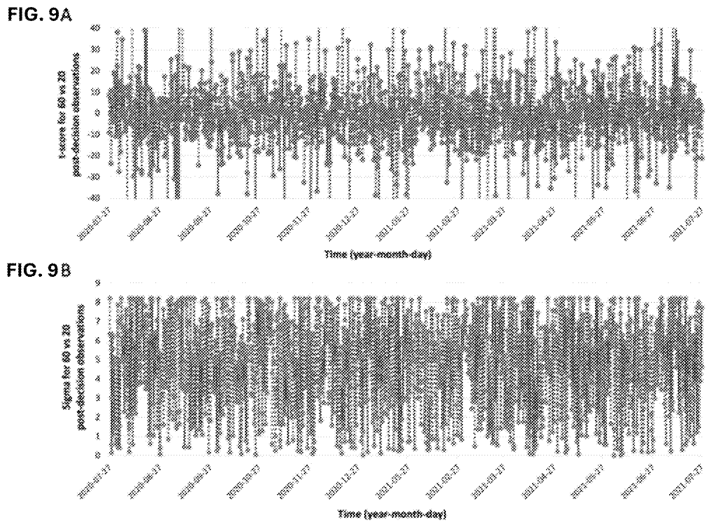

Mean pre-decision photon counts varied smoothly with lunar phase in the pre-filtered data, with an extreme valley at the first day of the new moon, and peaks at waning gibbous and first quarter phases (FIG. 8). An analysis of variance (ANOVA) revealed that the variability in photon counts across phases was statistically significant (F8=71.93, p<<0.00001). The clear and consistent variability with moon phase over the course of the year suggests that photon emission and/or absorption is related to lunar phase in a reliable way.

### Periodicities in Pre-Decision Means Across Post-Decision Durations

In the original experiment and in this replication, qualitative observations of the data indicated that mean pre-decision photon counts oscillated in a complex way that was related to post-decision durations, at frequencies above those eliminated by the high-pass filter. Pre-decision photon counts averaged across all time points did not differ significantly according to their post-decision durations (FIG. 8), indicating that no consistent CADS effect is obtained over longer time frames when periodicities in the photon counts are ignored. The observed periodicities were quantified statistically by calculating sigmas for comparisons of pre-decision photon counts across post-decision durations collected in 6-hour (21600-second) time windows.

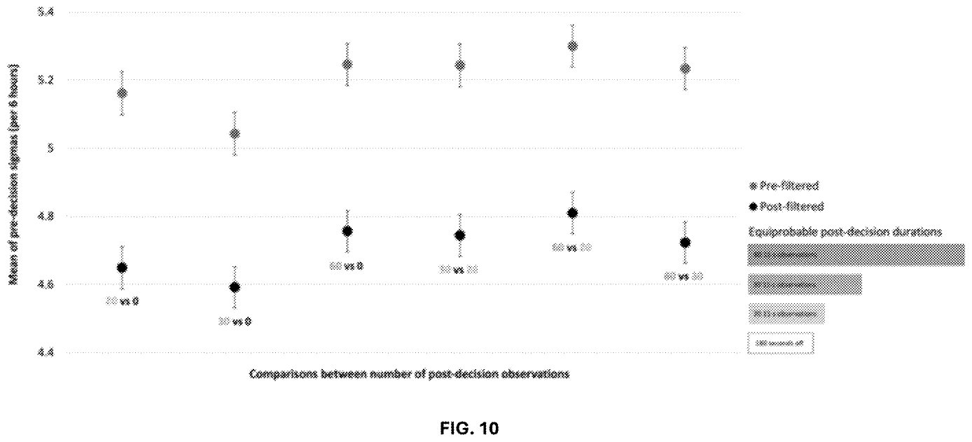

The grand mean of sigmas calculated across all 6-hour time windows and all post-decision durations was 4.71 for post-filtered data, and 5.21 for pre-filtered data, suggesting a large CADS effect occurs, on average, in each 6-hour time window, as long as the direction of the effect is ignored. Conservative estimates of pre-decision sigmas varied across comparisons, but all post-filtered sigma means were above 4.4 and below 4.9 (FIG. 10).

### Cads Equation: Estimating Pre-decision Peak Magnitudes

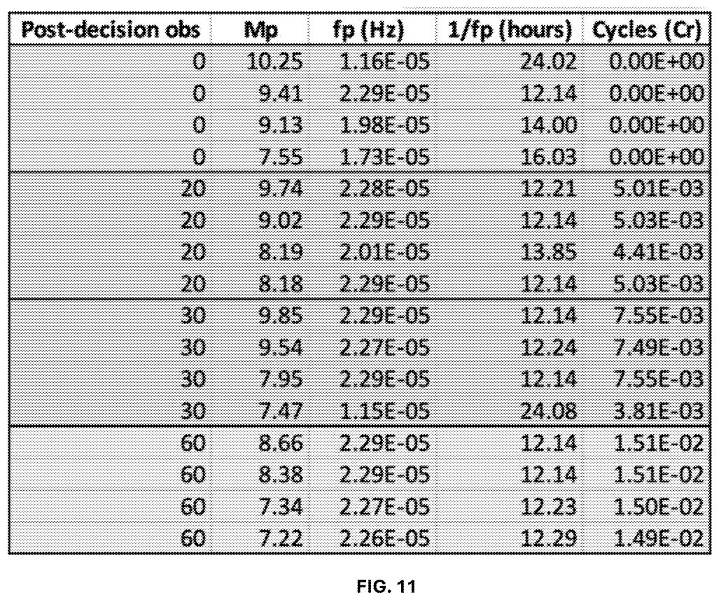

The single-sided spectrum of the post-filtered 6-hour windowed pre-decision means revealed that pre-decision means had peak magnitudes that differed depending on the post-decision duration (FIG. 11). This result echoed the initial qualitative observation that the periodicities of pre-decision photon count means seemed to be related to post-decision durations, and better quantified the CADS hypothesis by showing that the peak magnitudes of pre-decision means specific to different post-decision durations can be estimated from peak frequencies and the post-decision durations themselves.

Specifically, the best estimation of magnitudes at the first four frequency peaks required considering the frequency at the peak magnitude (fp) and the duration of the post-decision observation period for each run to obtain the unitless cycles per run (Cr):

obsp=post-decision obs×11 s (Equation 1)

Cr=fp×obsp (Equation 2)

Plotting Cr against the empirically obtained peak magnitudes of the pre-decision count means (Mp) further sheds light on the relationship between cycles per run and peak magnitudes. The best fit was a linear equation with R2=0.982:

Mp=−80.056×Cr+9.147 (Equation 3)

This equation, derived from mean peak frequencies, also fit the individual data values almost as well as the best fit equation (FIG. 8B). In addition, the best fit for the mean of the four top peaks (3) was very close to the best fit for the largest peak magnitudes alone (R2=0.961):

Mp1=−78.753×Cr1+9.1612 (equation 4)

where Mp1 indicates the largest peak magnitude and Cr1 indicates the cycles per run at the corresponding peak frequency. The CADS equation cannot be used to predict empirical results prior to the first time an experiment with given post-decision durations is performed, but it could be used to determine unknown post-decision durations once peak frequencies and magnitudes are known.

The number of post-decision durations selected in each of these four datasets was approximately 10.3 across post-decision durations, with a range of 10.2 to 10.32, and there were no significant differences in the number of post-decision durations across different post-decision duration datasets. In addition, the number of post-decision durations across the 1459 6-hour windows was not significantly correlated with pre-decision means in the same 6-hour windows for any post-decision duration (highest R\hat{ }2=0.0009, p>0.230). Finally, the independent frequency analyses for each of the four post-decision duration datasets used the same sampling rate (6 hours) and the same frequency axes for the resulting spectra were obtained. Thus, there was no information about post-decision durations embedded in the four independent time series of pre-decision means, suggesting that the CADS equation truly characterizes a relationship between pre-decision photon counts and the post-decision observation duration in CADS experiments.

While this specification contains many specific embodiment details, these should not be construed as limitations on the scope of any embodiment or of what can be claimed, but rather as descriptions of features that can be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the embodiments described above should not be understood as requiring such separation in all embodiments, and it should be understood that the described program components and systems can generally be integrated together in a single software product or packaged into multiple software products.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Particular embodiments of the subject matter have been described in this specification. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain embodiments, multitasking and parallel processing can be advantageous.

Publications and references to known registered marks representing various systems cited throughout this application are incorporated by reference herein. Citation of any above publications or documents is not intended as an admission that any of the foregoing is pertinent prior art, nor does it constitute any admission as to the contents or date of these publications or documents. All references cited herein are incorporated by reference to the same extent as if each individual publication and reference were specifically and individually indicated to be incorporated by reference.

While the invention has been particularly shown and described with reference to a preferred embodiment thereof, it will be understood by those skilled in the art that various changes in form and details may be made therein without departing from the spirit and scope of the invention. As such, the invention is not defined by the discussion that appears above, but rather is defined by the claims that follow, the respective features recited in those claims, and by equivalents of such features.

What is claimed is:

1. An optical measurement system comprising:
(a) a photon detector configured to collect photon count data during a first observation window;
(b) a parameter selection module configured to establish a operational state of the optical measurement system from among a plurality of equiprobable states after the photon count data of first observation window has been recorded; and
(c) a processor communicatively coupled to the photon detector, the processor configured to:
(i) apply a filter to the collected photon count data to produce filtered photon count data;
(ii) perform a frequency-domain transform on the filtered photon count data to obtain a frequency spectrum;
(iii) identify at least one spectral characteristic in the frequency spectrum;
(iv) compute a derived value based on the at least one spectral characteristic; and
(v) determine the operational parameter based on a predetermined relationship between the derived value and the at least one spectral characteristic.

2. The optical measurement system of claim 1, wherein the first observation window comprising a plurality of defined observation intervals, each observation interval having a defined temporal duration.

3. The system of claim 1, wherein the operational parameter is a post-decision observation duration.

4. The system of claim 1, wherein the filter comprises a high-pass filter configured to attenuate periodicities having periods above a threshold period.

5. The system of claim 1, wherein the frequency-domain transform is a Fast Fourier Transform.

6. The system of claim 1, wherein the at least one spectral characteristic comprises a peak magnitude and a corresponding peak frequency.

7. The system of claim 5, wherein the derived value is a cycles-per-run value computed from the corresponding peak frequency and a post-decision observation time.

8. The system of claim 6, wherein the predetermined relationship is a linear relationship of the form M_p=a×C_r+b, where M_p is the peak magnitude, C_r is the cycles-per-run value, and a and b are empirically derived constants.

9. The system of claim 2, wherein the plurality of equiprobable states corresponds to four post-decision observation durations.

10. A method of determining a duration parameter associated with an optical measurement system, the method comprising:
(a) collecting, via a photon detector, photon count data during a pre-decision observation window comprising a plurality of defined observation intervals, each observation interval having a defined temporal duration, wherein a total post-decision observation duration is selected from among a plurality of equiprobable durations after the photon count data of the pre-decision observation window has been recorded;
(b) applying a high-pass filter to the collected photon count data to attenuate periodicities having periods above a threshold period, thereby producing filtered photon count data;
(c) performing a Fourier transform on the filtered photon count data to obtain a frequency spectrum;
(d) identifying at least one peak magnitude and a corresponding peak frequency in the frequency spectrum;
(e) computing a cycles-per-run value based on the corresponding peak frequency and a post-decision observation time; and
(f) determining the duration parameter based on a predetermined relationship between the cycles-per-run value and the peak magnitude.

11. The method of claim 10, wherein the predetermined relationship is a linear relationship of the form Mp=a×Cr+b, where Mp is the peak magnitude, Cr is the cycles-per-run value, and a and b are empirically derived constants.

12. The method of claim 10, wherein each defined observation interval has a temporal duration of approximately 11 seconds.

13. The method of claim 10, wherein the pre-decision observation window comprises three observation intervals recorded prior to the selection of the total post-decision observation duration.

14. The method of claim 10, wherein the plurality of equiprobable durations comprises four durations corresponding to 0, 20, 30, and 60 post-decision observation intervals.

15. The method of claim 10, wherein the high-pass filter is an exponential-ramp high-pass filter configured to attenuate periodicities having periods of approximately 57 hours and above to substantially zero.

16. The method of claim 10, further comprising computing the filtered photon count data as windowed means over time windows of a defined duration prior to performing the Fourier transform.

17. The method of claim 16, wherein each time window has a duration of approximately 6 hours.

18. The method of claim 10, further comprising a calibration step, wherein the predetermined relationship is established by:
(i) operating the optical measurement system over a calibration period using known post-decision observation durations;
(ii) collecting pre-decision photon count data during the calibration period;
(iii) performing steps (b) through (d) on the calibration data grouped by post-decision duration; and
(iv) fitting a linear model relating cycles-per-run values to peak magnitudes across the known post-decision durations.

19. The method of claim 10, wherein the post-decision observation duration is selected by a random number generator that is informationally isolated from the photon detector.

20. A method of compensating photon-count measurements for lunar-phase-correlated variability, the method comprising:
(a) operating a photon counting system over a calibration period spanning a plurality of complete lunar cycles, the photon counting system comprising a photon detector configured to record photon counts over defined observation intervals;
(b) determining a lunar phase corresponding to each observation interval based on a timestamp associated with the observation interval;
(c) computing a mean photon count for each of a plurality of defined lunar phases based on the photon counts recorded during the calibration period;
(d) deriving a lunar-phase correction function based on the computed mean photon counts; and
(e) applying the lunar-phase correction function to subsequent photon-count measurements to compensate for systematic variability attributable to lunar phase.
